(19) United States
(12) Patent Application Publication
(10) Pub. No.: US 2019/0163321 A1
(43) Pub. Date: May 30, 2019

(54) DISPLAY DEVICE

(71) Applicant: Sharp Kabushiki Kaisha, Sakai City (JP)

(72) Inventor: Takashi KONDOH, Sakai City (JP)

(21) Appl. No.: 16/200,726

(22) Filed: Nov. 27, 2018

(30) Foreign Application Priority Data
Nov. 30, 2017 (JP) 2017-230257

(51) Int. Cl. G06F 3/041; G06F 3/044

(52) U.S. Cl. CPC G06F 3/0418; G06F 2203/04102; G06F 3/044

(57) ABSTRACT

Provided is a technique of reducing misdetection of a touch position due to noises in an electrostatic capacitance caused by external stress.

A display device 1 includes: a display panel 2 including a touch detection unit Tx, Rx for detecting a touch position by an electrostatic capacitance method; a flexible substrate 5 connected with the display panel 2; and a frame body that houses the display panel 2 and the flexible substrate 5. The touch detection unit Tx, Rx outputs a sensor output value according to an electrostatic capacitance at a touch position. The flexible substrate 5 includes: a detection unit 5a that detects a position change of the touch surface on the display panel 2 in the frame body; and a control unit 10 that adjusts the touch position based on a detection result obtained by the detection unit 5a and the sensor output value.

### TECHNICAL FIELD

The present invention relates to a display device, and particularly relates to a display device having a touch detection function.

### BACKGROUND ART

In recent years, display devices having a touch detection function of detecting a touch position by the electrostatic capacitance method are in widespread use, and a variety of techniques for improving the detection of a touch position (hereinafter referred to as “the touch position detection”)accuracy have been proposed. Patent Document 1 discloses a technique of compensating a result of detection of an electrostatic capacitance based on environmental conditions under which a display device is used. More specifically, in the configuration disclosed in Patent Document 1, changes in capacitances according to external environments are measured by reference trace, which is separated from touch sensors, and measured values determined by reference trace are removed from the changes in capacitances measured by the touch sensors.

### PRIOR ART DOCUMENT

### Patent Document

### Patent Document 1: JP-A-2012-33172

### SUMMARY OF THE INVENTION

### Problem to be Solved by the Invention

Incidentally, in a display device having a touch detection function of an electrostatic capacitance type, electrodes or the like for touch detection are provided in a display panel thereof (hereinafter referred to as a touch panel) in some cases. Such a display device is also applied to a mobile terminal such as a smartphone, and in recent years, users who play games and other applications on such mobile terminals have increased. A user who is absorbed in a game sometimes touches a display surface of a mobile terminal with greater force than that of a normal touching operation. When strong stress is applied to the display surface, the display panel of the mobile terminal is deflected. The deflection of the display panel causes the position level of the touch panel provided in the display panel to change, thereby causing the electrostatic capacitance detected from the touch panel to include noise components of the changes in the electrostatic capacitance due to changing in the position level of the touch panel. If the detection of a touch position is performed by using this detection result, it is therefore impossible to appropriately determine a touch position.

It is an object of the present invention to provide a technique of reducing misdetection of a touch position due to noises in an electrostatic capacitance caused by external stress.

### Means to Solve the Problem

A display device in one embodiment of the present invention includes: a display panel including a touch detection circuitry for detecting a touch position by an electrostatic capacitance method; a flexible substrate connected with the display panel; and a frame body that houses the display panel and the flexible substrate, wherein the touch detection circuitry outputs a sensor output value according to an electrostatic capacitance at a touch position, and the flexible substrate includes: a detection circuitry that detects a position change of the touch surface on the display panel in the frame body; and a control circuitry that adjusts the touch position based on a detection result obtained by the detection circuitry and the sensor output value.

### Effect of the Invention

With the present invention, it is possible to reduce misdetection of a touch position due to noises in an electrostatic capacitance caused by external stress.

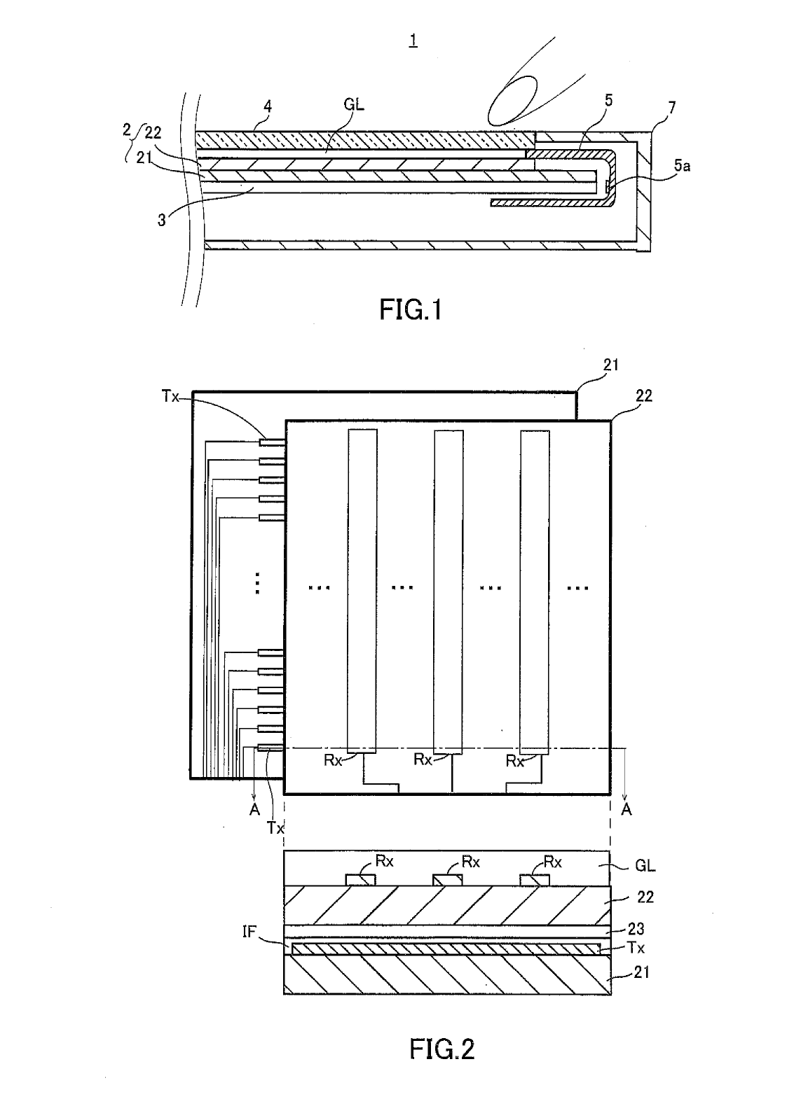

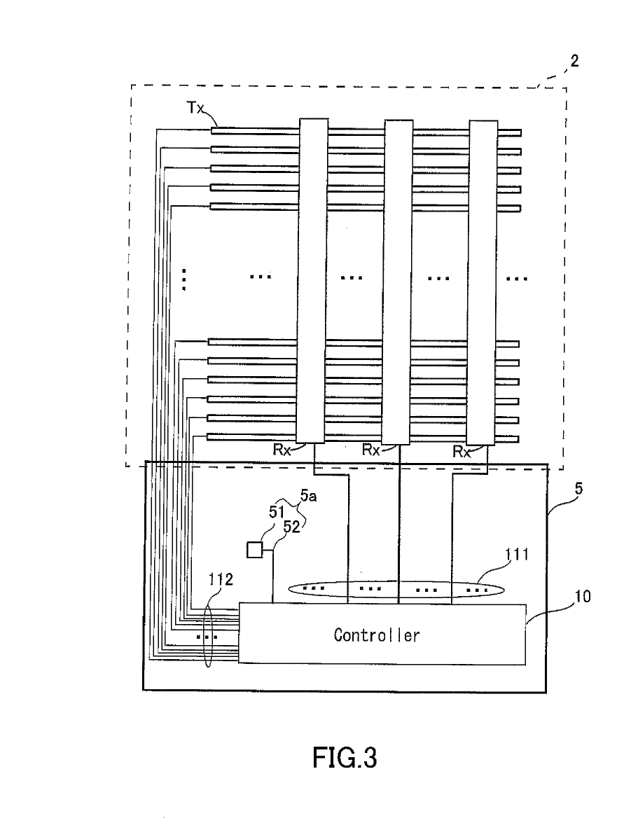

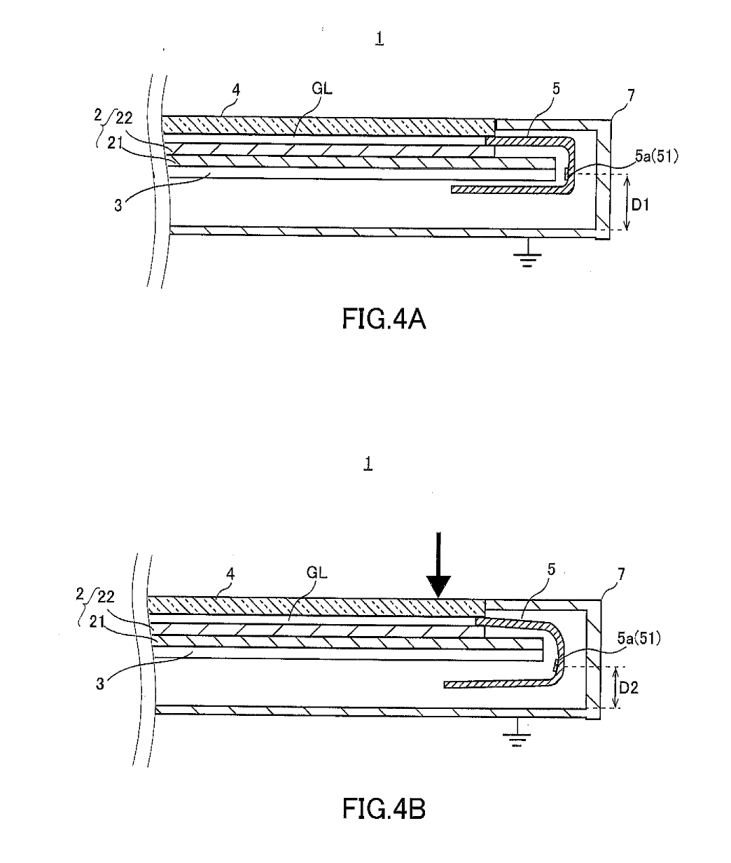

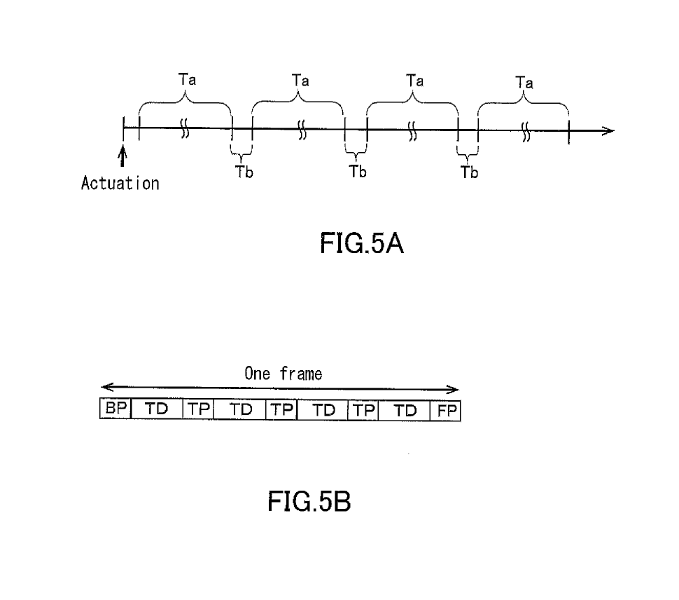

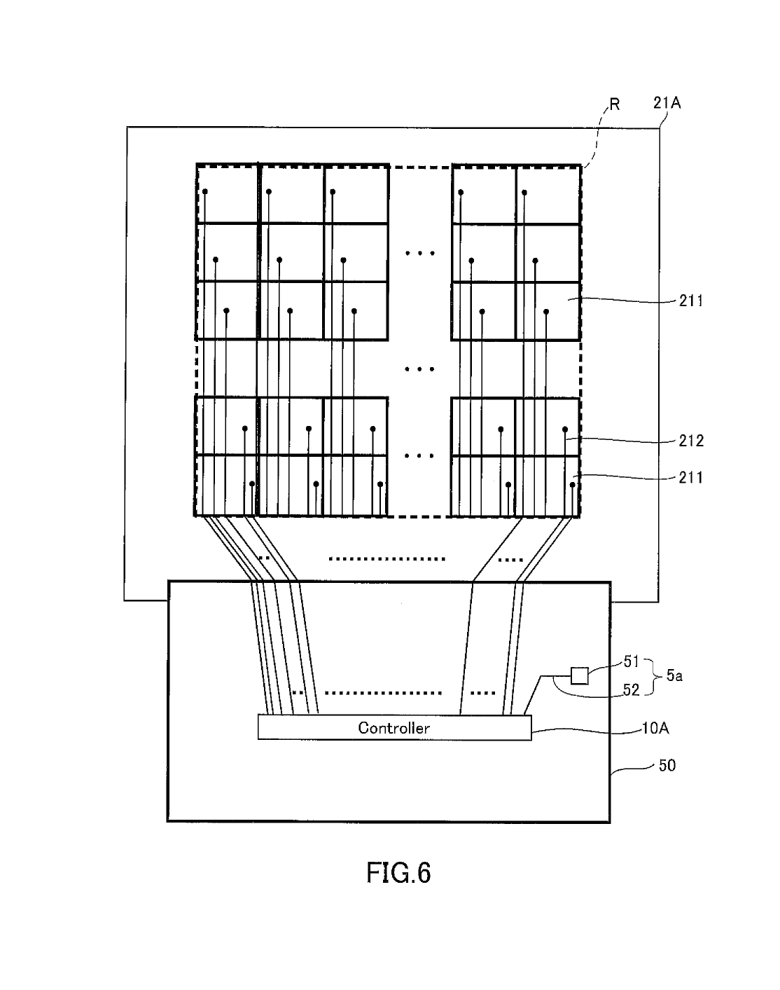

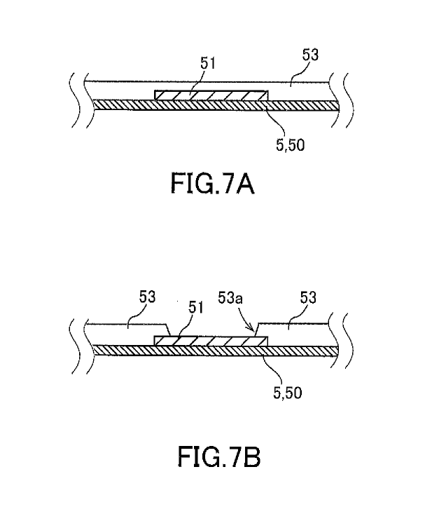

### BRIEF DESCRIPTION OF DRAWINGS

[FIG. 1] FIG. 1 is a schematic cross-sectional view of a display device in an embodiment.

[FIG. 2] The upper part of FIG. 2 is a plan view illustrating a configuration of the touch panel unit provided in a display panel illustrated in FIG. 1, and the lower part of FIG. 2 is a cross-sectional view taken along line A-A illustrated in the plan view of the upper part.

[FIG. 3] FIG. 3 is a plan view of a flexible substrate connected with drive electrodes and sense electrodes illustrated in FIG. 2.

[FIG. 4A] FIG. 4A illustrates a reference potential (ground voltage) set at a chassis illustrated in FIG. 1.

[FIG. 4B] FIG. 4B illustrates a state in which external stress is applied to the display surface in the state illustrated in FIG. 4A.

[FIG. 5A] FIG. 5A illustrates timings for detecting a touch position and detecting a position change detection signal.

[FIG. 5B] FIG. 5B illustrates timings in one frame for executing the image display and the touch position detection.

[FIG. 6] FIG. 6 schematically illustrates a schematic configuration of an active matrix substrate and a flexible substrate connected to the active matrix substrate in Modification Example (1).

[FIG. 7A] FIG. 7A is a schematic cross-sectional view illustrating a configuration of a terminal part of a flexible substrate in Modification Example (2).

[FIG. 7B] FIG. 7B is a schematic cross-sectional view illustrating a configuration of a terminal part of a flexible substrate different from that illustrated in FIG. 7A.

### MODE FOR CARRYING OUT THE INVENTION

A display device in one embodiment of the present invention includes: a display panel including a touch detection circuitry for detecting a touch position by an electrostatic capacitance method; a flexible substrate connected with the display panel; and a frame body that houses the display panel and the flexible substrate, wherein the touch detection circuitry outputs a sensor output value according to an electrostatic capacitance at a touch position, and the flexible substrate includes: a detection circuitry that detects a position change of the touch surface on the display panel in the frame body; and a control circuitry that adjusts the touch position based on a detection result obtained by the detection circuitry and the sensor output value (the first configuration).

According to the first configuration, when the flexible substrate deflects, the position of the detection circuitry provided in the flexible substrate changes. When the position of the detection circuitry changes, the position of the touch surface on the display panel highly possibly changes, and therefore, it is possible to detect whether or not the position of the touch surface has changed, by referring to the detection result obtained by the detection circuitry. The position of the touch detection circuitry changes due to the position change of the touch surface. Since the control circuitry adjusts the touch position based on the detection result obtained by the detection circuitry and the sensor output value of the touch detection circuitry, misdetection of a touch position can be reduced, as compared with a case where the touch position is adjusted by using only the sensor output value that contains noise components of the electrostatic capacitance due to the position change of the touch surface.

The first configuration may be further characterized in that the detection circuitry detects a change in the electrostatic capacitance at a position of the detection circuitry, and the control circuitry detects the touch position based on a reference value of the sensor output value for the detection of the touch position, and the sensor output value, and only in a case where the detection result obtained by the detection circuitry is within a first range, the reference value of the sensor output value is calibrated based on the detection result (the second configuration).

Such strong stress that the position of the touch surface is changed is not applied to the touch surface so frequently. If the reference value of the sensor output value is calibrated based on the position change of the touch surface in a case where a change in the electrostatic capacitance detected by the detection circuitry is beyond the first range, there is a possibility that an incorrect touch position could be detected in a subsequent operation of the touch position detection. According to the second configuration, the reference value of the sensor output value is calibrated based on the detection result obtained by the detection circuitry, only in a case where the change in the electrostatic capacitance at the position of the detection circuitry is within a predetermined range. In other words, in a case where the detection result obtained by the detection circuitry is beyond the predetermined range, the reference value of the sensor output value is not calibrated. This makes it possible to detect a touch position by using the reference value of the sensor output value, which is more suitable, thereby reducing misdetection of a touch position.

The first configuration may be further characterized in that the detection circuitry detects a change in the electrostatic capacitance at the position of the detection circuitry, and in a case where the detection result obtained by the detection circuitry is not within a second range, the control unit does not use any sensor output value that is output during a certain period starting when the said detection result is obtained, in the touch position detection (the third configuration).

A sensor output value that is output when such stress that the position of the touch surface changes is applied to the touch surface highly possibly contains a noise component of an electrostatic capacitance due to a position change of the touch surface, that is, a position change of the touch detection circuitry in the display panel. According to the third configuration, in a case where the detection result obtained by the detection circuitry is not within the second range, a sensor output value that is output during a certain period starting when the detection result is obtained is not used in the touch position detection. This makes it possible to reduce misdetection of a touch position.

Any one of the first to third configurations may be further characterized in that the detection circuitry detects a position change of the touch surface, at a timing different from the timing for the touch position detection by the touch detection circuitry (the fourth configuration).

The frequency at which such stress that the position of the touch surface changes is applied to the touch surface is lower than the frequency at which the display surface is touched with normal force. According to the fourth configuration, the position change of the touch surface is detected during a period while the touch position detection is not executed. The operation for the touch position detection can be performed at a high speed, as compared with a case where the detection operations are performed at the same timing.

Any one of the first to fourth configurations may be further characterized in that the control circuitry detects a position change of the touch surface based on a change in an electrostatic capacitance between the detection circuitry and either one of a front surface and a back surface of the frame body (the fifth configuration).

When the flexible substrate deflects, the position of the detection circuitry changes. With the fifth configuration, a position change of the detection circuitry can be detected by detecting a change in the electrostatic capacitance between the detection circuitry and the front or back surface of the frame body, and the position change of the touch surface can be detected according to the detection result.

The following description describes an embodiment of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of a part of constituent members is omitted. Further, the dimension ratios of the constituent members illustrated in the drawings do not necessarily indicate the real dimension ratios.

FIG. 1 is a schematic cross-sectional view of a display device in the present embodiment. The display device 1 in the present embodiment is a display device that includes a touch panel unit (touch detection unit) for detecting a touch position by the electrostatic capacitance method.

As illustrated in FIG. 1, the display device 1 includes a display panel 2, a backlight 3 provided on a bottom side of the display panel 2, a cover glass 4 that covers a surface of the display panel 2, a flexible substrate 5 connected with the display panel 2, and a chassis 7 that supports the display panel 2. A space between the display panel 2 and the cover glass 4 is filled with glue GL, whereby the display panel 2 and the cover glass 4 are bonded with each other.

To an end of the display panel 2, the flexible substrate 5 is connected. The flexible substrate 5 is bent in such a manner that an end thereof that is not connected to the display panel 2 goes around the backlight 3 toward the bottom side thereof, inside the chassis 7. On the bending part of the flexible substrate 5, a detection unit 5a is provided. The detection unit 5a detects a position change of the detection unit 5a that occurs due to deflection of the flexible substrate 5 caused by external stress. Details of the detection unit 5a are described below.

The display panel 2 includes an active matrix substrate 21, and a counter substrate 22 provided so as to be opposed to the active matrix substrate 21. Though the illustration is omitted in this drawing, a liquid crystal layer is provided between the active matrix substrate 21 and the counter substrate 22, and a pair of polarizing plates are provided so that the active matrix substrate 21 and the counter substrate 22 are interposed therebetween.

The active matrix substrate 21 has a display area composed of a plurality of pixels defined by gate lines and data lines, and each pixel is provided with a pixel electrode and a thin film transistor (TFT) (all unillustrated). Further, the active matrix substrate 21, in its frame region, includes a gate line scanning circuit that sequentially scans the gate lines of the respective pixels, a data line driving circuit that supplies data signals to the data lines of the respective pixels, and a display control circuit that controls the gate line scanning circuit and the data line driving circuit so as to display an image in the display area (all unillustrated).

The counter substrate 22, on a surface on the active matrix substrate 21 side, includes common electrodes, color filters corresponding to colors of red (R), green (G), and blue (B), and a black matrix provided between adjacent ones of the color filters (all unillustrated). Each pixel on the active matrix substrate 21 corresponds to any one of the colors of R, G, and B.

FIG. 2 is a plan view illustrating a configuration of the touch panel unit provided in the display panel 2, and a cross-sectional view taken along line A-A in the plan view.

As illustrated in FIG. 2, in the present embodiment, the display panel 2 is provided with the touch panel unit (touch detection circuitry) having sense electrodes Rx and drive electrodes Tx. The sense electrodes Rx are provided on a surface of the counter substrate 22, on a side thereof opposite to the active matrix substrate 21. The drive electrodes Tx are provided in a layer upper with respect to the pixel electrodes (not illustrated), on a liquid crystal layer 23 side surface of the active matrix substrate 21, and an insulating film IF is provided between the liquid crystal layer 23 and the drive electrodes Tx. The drive electrodes Tx are formed with a metal such as copper (Cu), and the sense electrodes Rx are formed with transparent conductive films made of, example, indium tin oxide (ITO).

The drive electrodes Tx and the sense electrodes Rx are connected to the flexible substrate 5 illustrated in FIG. 1. FIG. 3 is a plan view of the flexible substrate 5 connected with the drive electrodes Tx and the sense electrodes Rx.

As illustrated in FIG. 3, the flexible substrate 5 is provided with a controller 10 that controls the drive electrodes Tx and the sense electrodes Rx. The controller 10 and the sense electrodes Rx are connected with each other by sense lines 111, and the controller 10 and the drive electrodes Tx are connected with each other by drive lines 112.

The controller 10 applies a predetermined voltage to the drive lines 112 sequentially so as to scan the drive electrodes Tx, and controls the sense electrodes Rx via the sense lines 111 so that the sense electrodes Rx have a predetermined potential (bias potential) at predetermined timings.

In the present embodiment, as illustrated in FIG. 4A, a potential at a part of the chassis 7 on the side of the bottom face of the display panel 2 is set as a reference potential (GND). FIG. 4A illustrates a non-contact state in which a user's finger or the like is not in contact with the display surface.

When a user's finger or the like comes into contact with the display surface, electric signals (hereinafter referred to as sense signals) corresponding to changes in electric fields generated between the same and the drive electrodes Tx and the sense electrodes Rx (see FIGS. 2, 3, etc.) are input to the controller 10 through the sense lines 111. The controller 10 detects a touch position based on an electrostatic capacitance value that serves as a reference for the sense signal (hereinafter referred to as a sense signal reference value), and the sense signals. Incidentally, the sense signal reference value is a value according to the electrostatic capacitance between the drive electrodes Tx and the sense electrodes Rx measured in the non-contact state.

As illustrated in FIG. 3, the detection unit 5a is composed of a terminal 51 and a line 52 connected with the terminal 51, which are provided on the flexible substrate 5. The terminal 51 and the line 52 are provided at positions that are as far from the drive lines 112 and the sense lines 111 as possible, on the flexible substrate 5. The terminal 51 is formed with a conductive material such as copper (Cu), and has an area of several square millimeters. The line 52 is made of the same material as that of the sense line 111.

The controller 10 controls the terminal 51 via the line 52 so that the terminal 51 has a predetermined potential at predetermined timings, and acquires an electric signal indicating a change in a position level of the terminal 51 due to press on the display panel 2 via the line 52. Hereinafter a change in the position level of the terminal 51 is referred to as a position change of the terminal 51, and the electric signal indicating the position change of the terminal 51 is referred to as a position change detection signal. The controller 10 determines whether or not a difference between the acquired position change detection signal and an electrostatic capacitance value that serves as a reference for the position change of the terminal 51 (hereinafter referred to as a position change reference value) is within a predetermined range. Incidentally, the distance between the center of the terminal 51 and the bottom face part of the chassis 7 in the non-contact state illustrated in FIG. 4A is D1. As the position change reference value, a value is set in accordance with an electrostatic capacitance between the terminal 51 and the surface of the chassis 7 on which the GND is set, measured in the non-contact state, that is, when the distance between the surface of the chassis 7 and the center of the terminal 51 is D1.

FIG. 4B illustrates a state in which the surface of the cover glass 4 is pressed. When strong external stress is applied to the surface of the cover glass 4, the display panel 2 is deflected, that is, the position level of the touch surface changes, and the flexible substrate 5 is deflected. When the touch surface is pressed, the display panel 2 is pressed down in the normal direction of the display panel 2, and the position level of the touch surface changes; this change is hereinafter referred to as a “position change of the touch surface”. This causes the position level of the terminal 51 of the detection unit 5a changes toward the bottom face of the chassis 7, as compared with the case illustrated in FIG. 4A. In other words, the distance between the chassis 7 and the center of the terminal 51 changes from D1 to D2 (D2<D1).

In the present embodiment, since the GND (Ground) is set on the bottom face of the chassis 7, the deflection of the flexible substrate 5 causes the terminal 51 of the detection unit 5a to approach the part having the GND, thereby causing the electrostatic capacitance between the terminal 51 and the surface of the chassis 7 on which the GND is set to increase to a level greater than the position change reference value. In this example, the GND is set on the bottom face of the chassis 7, but the GND may be set on the top face of the chassis 7. In this case, since the deflection of the flexible substrate 5 causes the terminal 51 to be away from the top face of the chassis 7, the electrostatic capacitance between the terminal 51 and the top face of the chassis 7 becomes smaller than the position change reference value.

When the difference between the acquired position change detection signal and the position change reference value is within the threshold value range, the controller 10 determines that the sense signal does not contain any noise component generated by a position change of the touch surface, that is, the position change of the touch panel unit, and detects a touch position by using the sense signal.

On the other hand, in a case where the difference between the position change detection signal and the position change reference value is not within the threshold value range, the controller 10 determines that the sense signal contains a noise component generated by a position change of the touch panel unit. In this case, the controller 10 does not use sense signals that are output after the acquisition of the position change detection signal till a predetermined time, in the touch position detection. In other words, the controller 10 detects whether or not a position change occurs to the touch surface, that is, whether or not a position change occurs to any touch panel unit, by detecting a position change of the detection unit 5a, and detects whether or not the sense signal contains a noise component of an electrostatic capacitance generated by the position change.

Further, the controller 10 performs calibration when the display device 1 is actuated, or on another occasion, based on the position change detection signal. Calibration is a processing operation of calibrating the sense signal reference value based on the position change detection signal.

More specifically, when the difference between the position change detection signal and the position change reference value is within the threshold value range, the sense signal reference value is calibrated based on the difference. On the other hand, when the difference between the position change detection signal and the position change reference value is not within the threshold value range, the controller 10 does not execute the calibration. Such strong external stress that the difference between the position change detection signal and the position change reference value is beyond the threshold value range is not applied so frequently. If a position change detection signal value in such a case is used to calibrate the sense signal reference value, there is a high possibility that an appropriate touch position cannot be determined in a subsequent detection of the touch position. In the above-described case, therefore, calibration is not executed.

The following description describes timings for detecting a position change detection signal. FIG. 5A illustrates timings for detecting a touch position and detection of a position change detection signal. The period Ta illustrated in FIG. 5A is a normal driving period while image display and touch position detection are performed, and the period Tb is a position change detection period while a position change detection signal is detected. In the present embodiment, when the display device 1 is actuated, a position change detection signal is detected, and after the actuation, a position change detection signal is detected every several minutes. The calibration based on the position change detection signal is executed also during the period Tb for the detection of a position change detection signal. The normal driving period Ta has a duration of about several minutes, and the detection period Tb has a duration of, for example, about one microsecond.

The normal driving period Ta in FIG. 5A includes a plurality of frames, and the position change detection period Tb includes a partial segment of a certain frame. FIG. 5B illustrates timings for executing image display and touch position detection in one frame. As illustrated in FIG. 5B, in a period other than a horizontal scanning flyback period BP and a vertical scanning flyback period FP in one frame, the image display period TD and the touch position detection period TP are set so as to appear alternately. In one frame at the timing for detecting a position change detection signal, the controller 10 performs calibration based on the position change detection signal during periods other than the touch position detection period TP. For example, during the horizontal scanning flyback period BP or the vertical scanning flyback period FP in one frame, as the position change detection period Tb, the controller 10 performs calibration based on the position change detection signal.

In the embodiment described above, a position change of the detection unit 5a is detected according to a change in the electrostatic capacitance at the detection unit 5a provided in the flexible substrate 5, and it is detected based on the detection result whether or not any change has occurred to the position level of the touch surface, that is, the positions of the touch panel unit, due to a change of the shape of the display panel 2, such as deflection, depression, and the like. Then, a touch position is detected based on the detection result obtained by the detection unit 5a, and a sense signal value. Accordingly, misdetection of a touch position can be reduced, as compared with a case where a touch position is detected with a sense signal containing a noise component of an electrostatic capacitance generated due to a position change of the touch surface. In addition, in the embodiment described above, the sense signal reference value is calibrated according to the detection result obtained by the detection unit 5a, whereby a touch position can be detected more accurately, as compared with a case where a position change of the touch surface, that is, position changes of the touch panel unit, are not taken into consideration.

An exemplary display device according to the present invention is described above. The display device according to the present invention, however, is not limited to the above-described embodiment, and can be modified in many ways. The following description describes the modification examples.

(1) The above-described embodiment is described with reference to an example of a semi-in-cell type touch-panel-equipped display device in which the drive electrodes Tx and the sense electrodes Rx used only for touch position detection are provided in the display panel 2, but the configuration of the display device is not limited to this. For example, the display device may be a full-in-cell type touch-panel-equipped display device in which image display elements providing a function as a touch panel are provided in an active matrix substrate. The following description describes a display device of a modification example.

In the present modification example, the display device 1 has a configuration in which the method for driving the liquid crystal molecules contained in a liquid crystal layer 23 is the horizontal electric field driving method, and for the purpose of realizing the horizontal electric field driving method, pixel electrodes and counter electrodes (common electrodes) for forming electric fields are formed in the active matrix substrate.

FIG. 6 schematically illustrates a schematic configuration of an active matrix substrate 21A and a chip-on-film (COF) 50, which is a flexible substrate, connected to the active matrix substrate 21A in the present modification example. In this drawing, the illustration of image display elements such as gate lines, data lines, pixel electrodes, and TFTs provided on the active matrix substrate 21A is omitted. Besides, in this drawing, the COF 50 is illustrated as having a flat shape, but actually, inside the chassis 7 (see FIG. 1, etc.), an end thereof that is not connected with the active matrix substrate 21A is bend so as to be arranged on the back side of the active matrix substrate 21A.

As illustrated in FIG. 6, a plurality of counter electrodes 211 each of which has a rectangular shape are provided in matrix in a display area R of the active matrix substrate 21A. The counter electrodes 211 are provided in a layer upper with respect to pixel electrodes (not illustrated) on a surface of the active matrix substrate 21A, the surface being on the side of the liquid crystal layer 23 (see FIG. 3, etc.). Each of the counter electrodes 211 is, for example, approximately in a square shape whose side is several millimeters, and is larger than the pixel. Though the illustration is omitted in this drawing, in the counter electrodes 211, slits (having a width of, for example, several micrometers) are formed for causing horizontal electric fields to be generated between the same and the pixel electrodes (not illustrated).

Further, the COF 50 is provided with a controller 10A and a detection unit 5a. The controller 10A performs control for displaying images (hereinafter referred to as “image display control”), and at the same time, performs control for detecting a touch position (hereinafter referred to as “touch position detection control”). The controller 10A and each counter electrode 211 are connected with each other by a signal line 212. In other words, the signal lines 212, the number of which is the same as the number of the counter electrodes 211, are formed on the active matrix substrate 21.

The counter electrodes 211 are used, in pair with the pixel electrodes (not illustrated), in the image display control, as well as in the touch position detection control. In the present embodiment, during the image display period TD (see FIG. 5B), a constant direct current signal is supplied from the controller 10A to the counter electrodes 211 through the signal lines 212, so as to cause the counter electrodes 211 to function as the common electrodes. During the touch position detection period TP (see FIG. 5B), an alternate current signal having a constant amplitude (hereinafter referred to as a touch driving signal) is supplied to the counter electrodes 211 through the signal lines 212, so as to cause the counter electrodes 211 to function as the touch panel unit.

The detection of a touch position in this case is performed as follows. When a human finger or the like touches the display surface, a capacitor is formed between the human finger or the like and the counter electrode 211. In a operation of the touch position detection, each counter electrode 211 receives the touch driving signal supplied via the corresponding one of the signal lines 212, and outputs changes in the capacitance at the position of the counter electrode 211, via the signal line 212 to the controller 10A. In other words, an operation that includes the supply of the touch driving signal to every counter electrode 211 and the reception by the controller 10A of the sense signal from every counter electrode 211 is one operation of the touch position detection.

The detection unit 5a includes a terminal 51 and a line 52 identical to those in the embodiment. The line 52 is made of the same material as that of the signal lines 212, and is connected with the controller 10A. In the same manner as that in the embodiment, the controller 10A performs a controlling operation every fixed time period via the line 52 so that the terminal 51 has a predetermined potential, and acquires the position change detection signal; then, the controller 10A determines the touch position and performs calibration based on a difference between the position change detection signal and the position change reference value.

(2) The above-described embodiment is described with reference to an example in which one detection unit 5a is provided on a flexible substrate, but a plurality of the detection units 5a may be provided. Further, the above-described embodiment is described with reference to an example in which the terminal 51 has a rectangular shape, but the shape of the terminal 51 may be a circular shape or the like. Still further, as illustrated in FIG. 7A, the insulating film 53 may be provided so as to cover the terminal 51 on the flexible substrate 5, 50, and as illustrated in FIG. 7B, an opening 53a of the insulating film 53 may be provided above the terminal 51. Even if another element (a line or an electronic component) is provided on the flexible substrate, the insulating film 53 provided thereon prevents malfunctions from occurring due to physical short circuiting with these elements. Still further, in a case where the possibility of occurrence of malfunctions due to physical short circuiting with another element is low, the opening 53a provided allows a test substrate for testing whether or not the terminal 51 appropriately operates to be connected with the terminal 51 part of the opening 53a. This makes it possible to easily execute the operation verification of the terminal 51 when the display device 1 is shipped.

(3) The above-described embodiment is described with reference to an exemplary display device in which liquid crystal is used, but any configuration of the above-described embodiment or the above-described modification examples may be applied to a display in which organic electroluminescence (EL) is used.

(4) The above-described embodiment is described with reference to an exemplary display device in which the detection result obtained by the detection unit 5a is used in an operation of determining whether or not the sense signal is used in the detection of a touch position, and in an operation of calibration, but the configuration may be such that the detection result obtained by the detection unit 5a is used in only either one of the operations. In other words, for example, the detection result obtained by the detection unit 5a may be used only when the calibration is executed. Even with this configuration, a touch position is detected by using the sense signal, and the sense signal reference value with the position change of the detection unit 5a, that is, the position change of the touch surface, being taken into consideration. It is therefore possible to reduce misdetection of a touch position.

(5) The above-described embodiment is described with reference to an exemplary display device in which a touch position of the touch surface is detected by the detection unit 5a provided on the flexible substrate, which detects changes in an electrostatic capacitance at the position of the detection unit 5a, the changes being generated by a position change of the detection unit 5a. The method for detecting a position change of the touch surface, however, is not limited to this. For example, a position change of the touch surface may be detected by using a pressure sensor that detects pressing with respect to the touch surface, a distortion sensor that detects distortion of the touch surface.

(6) As the touch panel unit provided in the display panel 2, the drive electrodes Tx and the sense electrodes Rx are provided, in the embodiment described above, and the counter electrodes (common electrodes) 211 are provided in Modification Example (1) described above, while the controller 10, 10A is provided on the flexible substrate. The controller 10, 10A, however, may be included among the touch panel unit. In this case, for example, the controller 10, 10A may be provided in the active matrix substrate 21 of the display panel 2.

(7) In the embodiment described above, when whether or not the sense signal is used in the detection of a touch position is determined by using the detection result obtained by the detection unit 5a, and when whether or not the calibration is executed is determined by using the same, a common threshold value range is used with respect to the detection result obtained by the detection unit 5a; different threshold value ranges, however, may be used, respectively.

### DESCRIPTION OF REFERENCE NUMERALS

1: display device
2: display panel
3: backlight
4: cover glass
5: flexible substrate
5a: detection unit
21: active matrix substrate
22: counter substrate
23: liquid crystal layer
10, 10A: controller

### 50: COF

53: insulating film
111: sense line
112: drive line
211: counter electrode (common electrode)
212: signal line
Tx: drive electrode
Rx: sense electrode

1. A display device comprising:
a display panel including a touch detection circuitry for detecting a touch position by an electrostatic capacitance method;
a flexible substrate connected with the display panel; and
a frame body that houses the display panel and the flexible substrate,
wherein the touch detection circuitry outputs a sensor output value according to an electrostatic capacitance at a touch position, and
the flexible substrate includes:
a detection circuitry that detects a position change of the touch surface on the display panel in the frame body; and
a control circuitry that adjusts the touch position based on a detection result obtained by the detection unit and the sensor output value.

2. The display device according to claim 1,
wherein the detection circuitry detects a change in the electrostatic capacitance at a position of the detection circuitry, and
the control circuitry detects the touch position based on a reference value of the sensor output value for the detection of the touch position, and the sensor output value, and only in a case where the detection result obtained by the detection circuitry is within a first range, the reference value of the sensor output value is calibrated based on the detection result.

3. The display device according to claim 1,
wherein the detection circuitry detects a change in the electrostatic capacitance at the position of the detection circuitry, and
in a case where the detection result obtained by the detection circuitry is not within a second range, the control circuitry does not use any sensor output value that is output during a certain period starting when the said detection result is obtained, in the touch position detection.

4. The display device according to claim 1,
wherein the detection circuitry detects a position change of the touch surface, at a timing different from the timing for the touch position detection by the touch detection circuitry.

5. The display device according to claim 1,
wherein the control unit detects a position change of the touch surface based on a change in an electrostatic capacitance between the detection circuitry and either one of a front surface and a back surface of the frame body.
